(19) United States
(12) Patent Application Publication
(10) Pub. No.: US 2025/0328927 A1
(43) Pub. Date: Oct. 23, 2025

(54) SYSTEM AND METHOD FOR DATA COLLECTION

(71) Applicant: TOYOTA JIDOSHA KABUSHIKI KAISHA, Toyota-shi (JP)

(72) Inventor: Daisuke HASHIMOTO, Tokyo (JP)

(73) Assignee: TOYOTA JIDOSHA KABUSHIKI KAISHA, Toyota-shi (JP)

(21) Appl. No.: 18/643,053

(22) Filed: Apr. 23, 2024

(51) Int. Cl. G06Q 30/0201; G06Q 30/0283

(52) U.S. Cl. CPC G06Q 30/0206; G06Q 30/0283; G06Q 50/40

(57) ABSTRACT

Example embodiments of the present disclosure relate to efficiency and effectively collect data for artificial intelligence (AI)/Machine Learning (ML) models. According to example embodiments, a method, performed by a system for collecting data from a vehicle, is provided. The method may include: receiving data from the vehicle; obtaining a price list; validating the data based on the price list; based on determining that the data is validated, determining whether or not the data contributes to one or more improvements of at least one AI/ML model; based on determining that the data contributes to the improvement of the one or more performances, determining a price for compensating a user associated with the vehicle; and compensating the user based on the determined price.

### TECHNICAL FIELD

Example embodiments of the present disclosure relate to a data collection system, and more particularly, relate to a system and a method for collecting data for one or more artificial intelligence (AI)/machine learning (ML) models.

### BACKGROUND

In the process of training and testing AI/ML models, a significant amount of data is required. The accuracy of the data being utilized for training and/or testing an AI/ML model is crucial in producing an accurate and high-performance AI/ML model. Thus, obtaining a substantial amount of high-quality, real-world data for training and testing the AI/ML models is required.

Nevertheless, in the related art, accessing high-quality data, particularly under specific conditions or requirements, can be challenging. For example, obtaining images of a specific object in a specific location (e.g., a wild boar on a highway, etc.) and/or under a specific condition (e.g., a wild boar under 30° C., etc.) can pose significant challenges. Further, data associated with certain conditions or objects may be geographically limited, restricting access to relevant datasets for users located in different regions. For example, it may be difficult to collect data associated with a specific car model released only in certain regions.

Accordingly, the data being used for training and/or testing the AI/ML models in the related art have a limitation on data relevancy and specificity. Specifically, whenever the required amount of specific data is not available, generic or insufficient specific data may be utilized to train/test the AI/ML models, which may lead to models that lack precision and fail to accurately reflect real-world scenarios. Further, data variability, such as data under real-world conditions (e.g., weather, lighting, etc.) may be limited. These limitations hinder the ability to build comprehensive and representative AI/ML models across diverse geographical locations and scenarios.

Furthermore, in the related art, time and effort may be spent to collect a significant amount of data for the AI/ML models, but such data may not contribute to the improvement of the performance of the models due to, for example, overfitting. Rather, overfitting of the AI/ML models with inappropriate data may lead to ineffective models with reduced performance and missed opportunities for leveraging the collected data to deliver meaningful insights or accurate predictions, eventually rendering the collected data unhelpful or useless.

In view of at least the above reasons, there is a need to provide a solution to effectively and efficiently collect the required amount of data with the required quality under the required conditions.

### SUMMARY

Example embodiments consistent with the present disclosure provide methods, systems, and apparatuses for effectively and efficiently collecting real data from one or more vehicles for training and/or testing one or more AI/ML models.

According to example embodiments, a method performed by at least one processor of a system to collect data from a vehicle is provided. The method may include: receiving data from the vehicle; obtaining a price list; validating the data based on the price list; based on determining that the data is validated, determining whether or not the data contributes to one or more improvements of at least one AI/ML model, wherein the one or more improvements may include one or more of: an improvement in performance of the at least one AI/ML model, an improvement in test coverage, and an improvement in feature map coverage; based on determining that the data contributes to the one or more improvements, determining a price for compensating a user associated with the vehicle; and compensating the user based on the determined price.

According to example embodiments, a system for collecting data from a vehicle is provided. The system may include: a memory storage storing computer-executable instructions; and at least one processor communicatively coupled to the memory storage. The at least one processor may be configured to execute the instructions to: receive data from the vehicle; obtain a price list; validate the data based on the price list; based on determining that the data is validated, determine whether or not the data contributes to one or more improvements of at least one AI/ML model, wherein the one or more improvements may include one or more of: an improvement in performance of the at least one AI/ML model, an improvement in test coverage, and an improvement in feature map coverage; based on determining that the data contributes to the one or more improvements, determine a price for compensating a user associated with the vehicle; and compensate the user based on the determined price.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like reference numerals denote like elements, and wherein:

FIG. 1 illustrates a block diagram of an example system architecture 100, according to one or more example embodiments;

FIG. 2 illustrates example functional modules of a data collection system, according to one or more example embodiments;

FIG. 3A illustrates an example price list 300, according to one or more example embodiments;

FIG. 3B illustrates a diagram of an example feature map, according to one or more example embodiments;

FIG. 4 illustrates example functional modules of a vehicle system, according to one or more example embodiments;

FIG. 5 illustrates a block diagram of example components of the data collection system, according to one or more example embodiments;

FIG. 6 illustrates a block diagram of example components of the vehicle system, according to one or more example embodiments;

FIG. 7 illustrates a flow diagram of an example method performed by the data collection system to collect data from a vehicle, according to one or more example embodiments; and

FIG. 8 illustrates a flow diagram of an example method performed by the vehicle system to provide data to the data collection system, according to one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Furthermore, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Furthermore, the term “vehicle” described herein refers to a motorized vehicle such as a car, a truck, a bus, a motorcycle, or any other suitable type of automobile powered by an engine, motor, or other mechanical means. Alternatively or additionally, the “vehicle” described herein may also refer to a non-motorized vehicle, such as a bicycle, a skateboard, a roller skates, a kick scooter, and the like, without departing from the scope of the present disclosure.

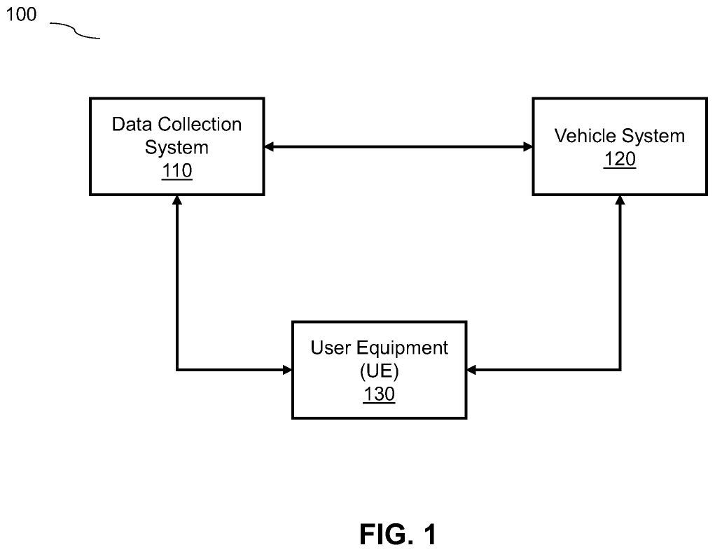

FIG. 1 illustrates a block diagram of an example system architecture 100, according to one or more example embodiments. As illustrated in FIG. 1, the system architecture 100 may include a data collection system 110, a vehicle system 120, and a user equipment (UE) 130. It is contemplated that the system architecture 100 in FIG. 1 is simplified for descriptive purposes, and the system architecture 100 may be different according to the actual implementation. For instance, a plurality of data collection system 110, a plurality of vehicle system 120, and/or a plurality of UE 130, may be utilized, without departing from the scope of the present disclosure.

In general, the data collection system 110 may collect data from the vehicle system 120, may process the collected data to validate and estimate a contribution of the data in improving the performance of one or more AI/ML models, and may then appropriately compensate a user of the UE 130. The vehicle system 120 may receive, from the user of the UE 130, an approval or an application to utilize the vehicle (or one or more onboard devices in the vehicle) to capture and provide data associated with an object, may capture data associated with the object and then transmit the captured data to the data collection system 110. The UE 130 may be utilized by the associated user to view or browse (from the data collection system 110) information of one or more data that can be collected and apply to take part in collecting the one or more data. The user may approve or apply for the data collection via the UE 130 and/or via the vehicle system 120.

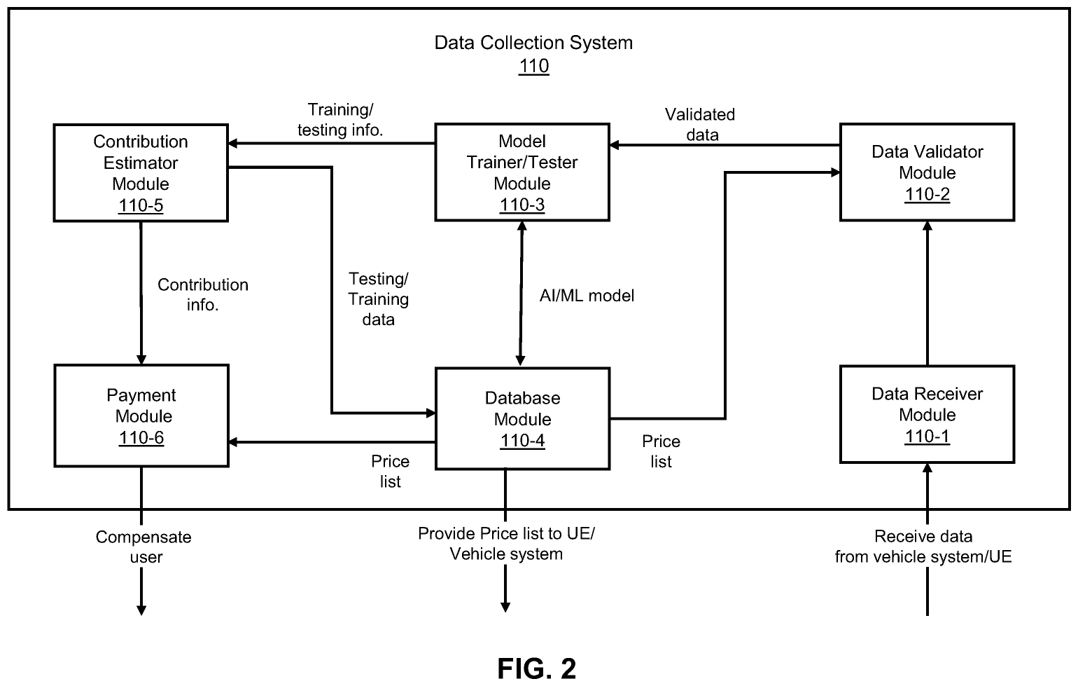

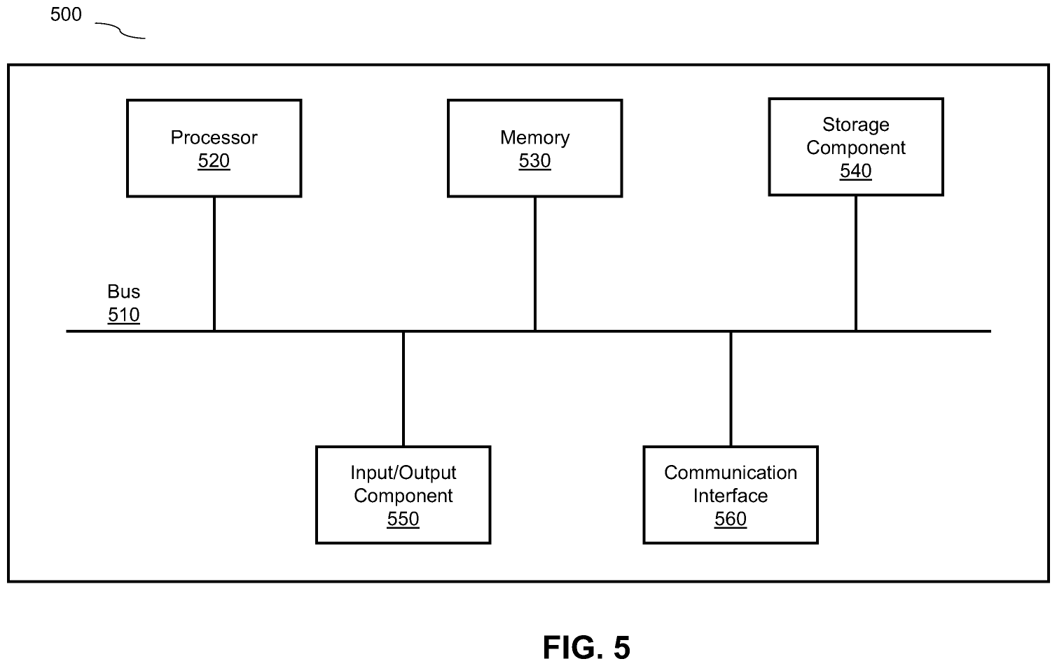

The data collection system 110 may be implemented or deployed in one or more servers outside of the vehicle system 120. For instance, the data collection system 110 may be implemented or deployed in one or more edge servers located nearer to the UE 130 and/or the vehicle system 120. As another example, the data collection system 110 may be implemented or deployed in one or more central servers located further from the UE 130 and/or the vehicle system 120. In some implementations, a portion of the data collection system 110 may be implemented or deployed in one or more edge servers while another portion of the data collection system may be implemented or deployed in one or more central servers. Further descriptions of example functional modules in the data collection system 110 are provided below with reference to FIG. 2, and further descriptions of the example components of a device (e.g., server, etc.) in which the data collection system 110 can be implemented are provided below with reference to FIG. 5.

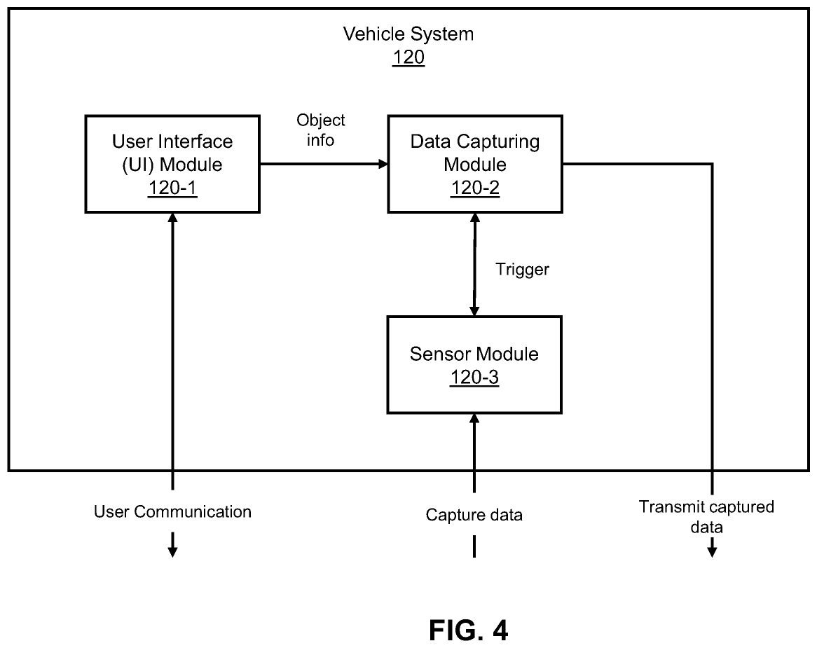

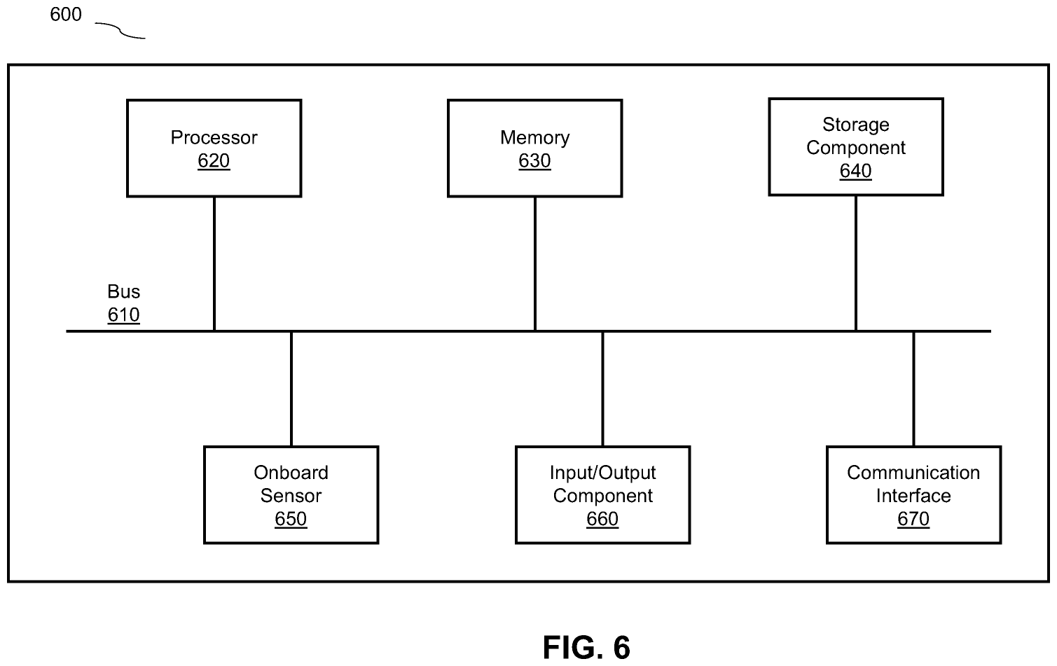

The vehicle system 120 may be implemented or deployed in a vehicle associated with the user of the UE 130. The vehicle may include any suitable type of motorized vehicle (e.g., a car, a bus, a truck, a motorcycle, etc.) or any suitable type of non-motorized vehicle (e.g., a bicycle, a kick scooter, etc.) Further descriptions of example functional modules in the vehicle system 120 are provided below with reference to FIG. 4, and further descriptions of the example components of a vehicle in which the vehicle system 120 can be implemented are provided below with reference to FIG. 6.

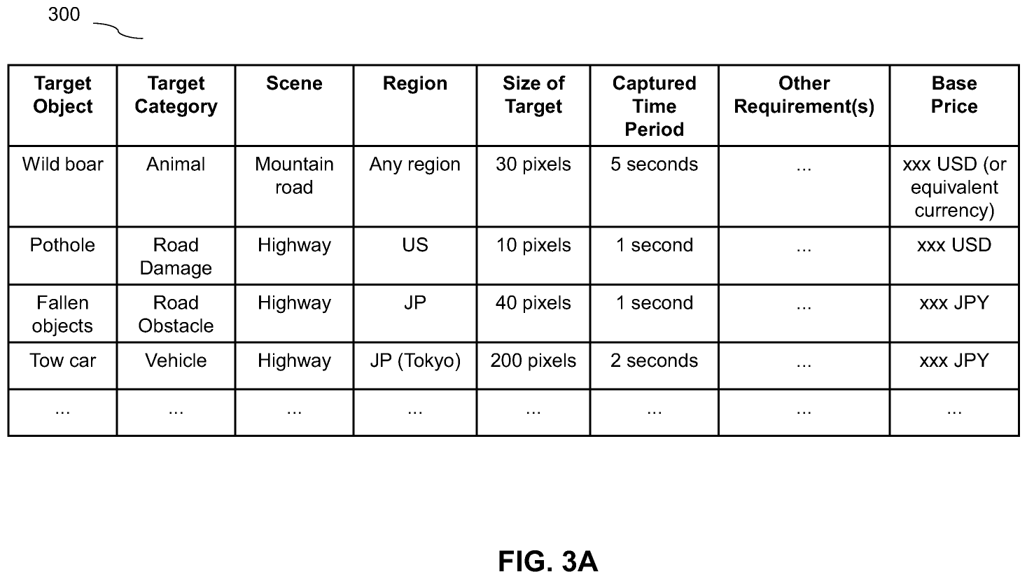

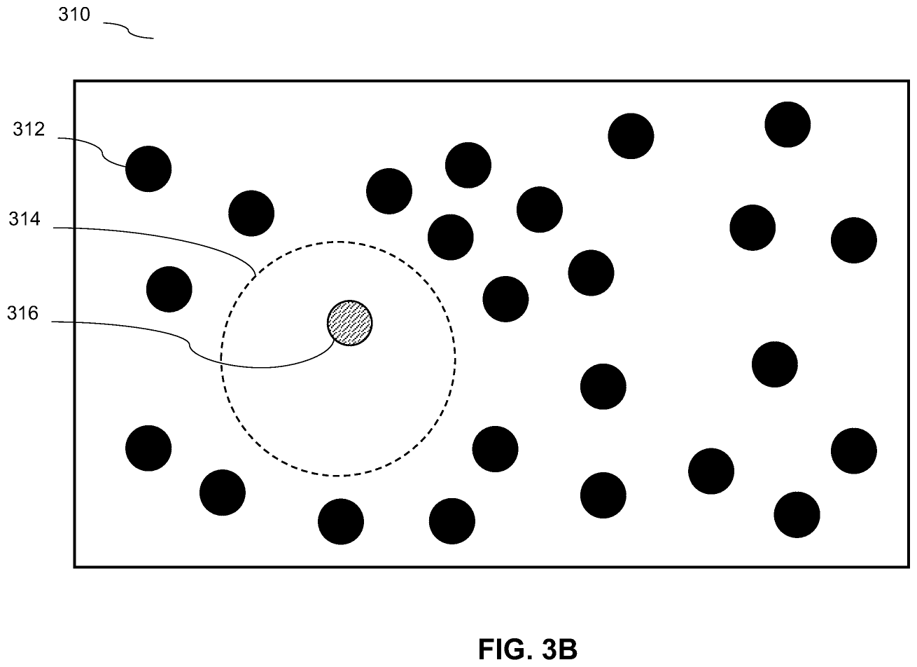

The UE 130 may be associated with one or more users (e.g., driver or owner of the vehicle in which the vehicle system 120 is implemented, etc.), and may be utilized by the associated user(s) to access the data collection system 110 and the vehicle system 120. Specifically, through the UE 130, the user may view or browse a price list or a catalog (provided by the data collection system 110) that includes information of one or more objects, such as one or more data requirements and the associated compensation price. Descriptions of an example price list are provided below with reference to FIG. 3A.

The UE 130 may include one or more devices or equipment, such as one or more of: a computing device (e.g., a desktop computer, a laptop computer, a tablet computer, a handheld computer, a smart speaker, a server, etc.), a mobile device (e.g., a smartphone, etc.), a SIM-based device, or any other suitable device which may be associated with the one or more users. In some embodiments, UE 130 may include a device that is part of or deployed in the vehicle (e.g., part of the in-vehicle infotainment (IVI) system of the vehicle, etc.)

The communication among the data collection system 110, the vehicle system 120, and/or the UE 130 may be performed through one or more wired communications and/or one or more wireless communications. For example, the communication may be performed via one or more of: a cellular network (e.g., a fifth generation (5G) network, a sixth generation (6G) network, a long-term evolution (LTE) network, a third generation (3G) network, a code division multiple access (CDMA) network, etc.), a public land mobile network (PLMN), a local area network (LAN), a closed area network (CAN), a wide area network (WAN), a metropolitan area network (MAN), a telephone network (e.g., a Public Switched Telephone Network (PSTN), etc.), a private network, an ad hoc network, an intranet, the Internet, a fiber optic-based network, or the like.

According to example embodiments, the data collection system 110, the vehicle system 120, and/or the UE 130 (and the associated user) may be located in different geographical locations. For instance, the data collection system 110 may be located in a first region and the vehicle system 120 may be located in a second region different from the first region. According to example embodiments in which multiple vehicle systems 120 are involved, the data collection system 110 may communicate with both vehicle system(s) located in the same region and vehicle system(s) located in a different region. In this way, the data collection system 110 may collect data from vehicles located in different regions. Similarly, the data collection system 110 may communicate with users located in different regions, thereby providing information of data to be collected at the region associated with each of the users and enabling the users (and the associated vehicles) to participate in the data collection procedures.

Referring to FIG. 2, which illustrates example functional modules of the data collection system 110, according to one or more example embodiments. As illustrated in FIG. 2, the data collection system 110 may include at least one data receiver module 110-1, at least one data validator module 110-2, at least one model trainer/tester module 110-3, at least one database module 110-4, at least one contribution estimator module 110-5, and at least one payment module 110-6.

One or more of the modules 110-1 to 110-6 may be implemented in different forms of hardware, firmware, or a combination of hardware and software. In this regard, it is contemplated that one or more operations described herein with reference to each of the modules 110-1 to 110-6 may be performed by a hardware (e.g., a processor, etc.) upon executing a software or computer-executable instructions for implementing the modules 110-1 to 110-6. Further, it is contemplated that one or more of the modules 110-1 to 110-6 may be consolidated into a single module or may be implemented in the form of multiple modules (e.g., data receiver module 110-1 and data validator module 110-2 may be combined into a data processing module, the model trainer/tester module 110-3 may be implemented in the form of a model trainer module and a model tester module, etc.), without departing from the scope of the present disclosure.

The data receiver module 110-1 may be configured to receive data from one or more vehicle systems (e.g., vehicle system 120) and/or one or more external devices (e.g., UE 130). The received data may include raw data or metadata captured by one or more onboard sensors of the vehicle systems, and may be received in the form of signals or encoded messages. Further, the received data may include data provided by the external devices, such as a request for information, raw data or metadata captured by the external devices, and the like. According to example embodiments, the data receiver module 110-1 may decode the signals/messages to obtain the data, and may perform one or more operations to preprocess the data before providing the data to other modules of the data collection system 110. For instance, the module 110-1 may enhance the data (e.g., by correcting errors or formatting), filter out non-related data, reduce noise in the data, convert the data into a specific format, and the like. According to example embodiments, the data may include one or more images, and the module 110-1 may perform one or more image processing on the one or more images, such as image sharpening, color correction, down-sampling, supervision, gamma correction, and the like. Subsequently, the module 110-1 may provide the enhanced or preprocessed data to the data validator module 110-2.

The data validator module 110-2 may be configured to validate the data provided by the data receiver module 110-1, thereby ensuring that the data is validated before providing the data to other modules of the data collection system 110. According to example embodiments, the module 110-2 may obtain, from the database module 110-4, a price list (or a data catalog) and then validate the data based on the price list.

Referring to FIG. 3A, which illustrates an example price list 300, according to one or more example embodiments. The price list 300 may be managed or configured by one or more users (e.g., vehicle manufacturer, manager or operator of the data collection system 110, etc.), and may be pre-stored in one or more storage mediums (e.g., database module 110-4, etc.)

As illustrated in FIG. 3A, the price list 300 includes a plurality of target objects (e.g., wild boar, pothole, fallen objects, tow car, etc.), data requirements (e.g., target category, scene, region, size of object, captured time period, etc.) associated with each of the target objects, and the base compensation price associated with each of the target objects. The data requirement may include a region requirement, which can be any available region, a specific country (e.g., the US, etc.), a specific city (e.g., Tokyo, etc.), a prefecture, a state, and the like. Further, the requirement on the size of the target object may be represented in the number of pixels the target object is in the data (e.g., image). The requirement on the captured time period may refer to the duration at which the target object is captured. The base compensation price may refer to the minimum price for compensating the user who provides valid and useful data, and can be defined in the currency selected or associated with the user, such as US Dollar (USD), Japanese Yen (JPY), and the like.

In this regard, the data validator module 110-2 may validate the data based on the price list by performing an object recognition to identify an object included in the data and determining whether or not the identified object is associated with at least one object included in the prices list. Accordingly, based on determining that the identified object is associated with at least one object included in the price list, the system may determine whether or not the data fulfills one or more data requirements associated therewith. Based on determining that the data fulfills the at least one data requirement, the data validator module 110-2 may determine that the data is validated.

By way of example, upon determining that the data includes an object pertaining to a “wild boar”, the data validator module 110-2 may determine whether or not the object is an animal, whether or not the data is captured at a specific location/scene (e.g., mountain road, etc.), whether or not the size of the object satisfies a specific size (e.g., whether or not the size of the object is equal to or larger than 30 pixels) in the data, whether or not the captured time period satisfies a predefined duration (e.g., whether or not the object appears in the data for at least five seconds), and/or the like. Accordingly, based on determining that one or more of the data requirements are satisfied, the module 110-2 may determine that the data is associated with the wild boar and is validated.

In some example embodiments, instead of or in addition to performing the object recognition, the data validator module 110-2 may generate and present one or more interfaces (e.g., graphical user interfaces (GUIs), etc.) to one or more human operators, requesting the one or more human operators to verify the data. Accordingly, the data validator module 110-2 may receive, from the one or more interfaces, one or more feedbacks from the one or more human operators, thereby determining whether or not the object in the data is associated with at least one object included in the price list, whether or not one or more data requirements associated with the object are satisfied, and the like. In this case, the data validator module 110-2 may determine, based on the one or more feedbacks, whether or not the data is validated.

According to example embodiments, the data validator module 110-2 may further determine whether or not the data is valid by checking whether or not the data is real data that was captured by the vehicle system (or one or more onboard sensors) or is fake data which was fabricated with malicious intent. For instance, the module 110-2 may implement authentication mechanisms (e.g., digital signature, cryptographic techniques, security protocols, etc.) to verify the source of the data and ensure the authenticity of data. Further, the module 110-2 may examine the integrity of the data by cross-referencing the data with data obtained from multiple sensors of the vehicle or with data previously provided by the vehicle, thereby identifying any discrepancies or inconsistencies between the data that indicate potential fake data. Accordingly, based on determining that the data fulfills at least one data requirement and is real data, the module 110-2 may determine that the data is validated. Otherwise, based on determining that the data does not satisfy the at least one data requirement or is fake data, the module 110-2 may determine that the data is invalid and may reject or discard the data.

Upon determining that the data is validated, the data validator module 110-2 may provide the data to the model trainer/tester module 110-3, such that the model trainer/tester module 110-4 may be configured to train and/or test one or more AI/ML models based on the validated data. Specifically, the module 110-3 may obtain the AI/ML model(s) and the validated data from the database module 110-4, and then train and/or test the AI/ML model(s) using various training algorithms (e.g., parameter tuning, cross-validation, training with mini-batches, transfer learning, federated learning, etc.) or testing algorithms (e.g., determining evaluation metrics, error analysis, statistical significance testing, etc.)

Upon training/testing an AI/ML model with the validated data, the module 110-3 may provide the information associated with the training and/or the testing to the contribution estimator module 110-5. Accordingly, the contribution estimator module 110-5 may be configured to determine whether or not the data being utilized to train and/or test the AI/ML model contributes to the improvement of the AI/ML model (e.g., an improvement in performance of the AI/ML models, an improvement in test coverage, an improvement in feature map coverage, etc.)

For instance, the training/testing information may include performance metrics of the AI/MI model upon being trained/tested with the data, such as accuracy, precision, F-score, average precision, and the like. In this case, the contribution estimator module 110-5 may determine whether or not any of the performance metrics improved upon utilization of the data (e.g., improved model accuracy after the AI/ML model is trained with the data, etc.)

In another example, the module 110-3 may test an existing trained model with test data and determine whether or not the test with the existing model fails with the test data, and then determine whether or not the data can contribute to enhancing the test data set with covering the test scenario (e.g., weak scene) that the model is supposed to be weak at.

In yet another example, the module 110-3 and/or the module 110-5 may generate a feature map based on the data and then examine the feature map. Referring to FIG. 3B, which illustrates a diagram of an example feature map 310, according to one or more example embodiments. As illustrated in FIG. 3B, the feature map 310 includes a plurality of feature points 312 of existing data, an area 314 of the feature map space which has been sparse with the existing data, and at least one feature point 316 according to the data that is newly collected via the data collection system 110. By examining the feature map, the module 110-3 and/or the module 110-5 can determine whether or not the data compensates to one or more areas of the feature map space that were previously sparse with the existing datasets.

It is contemplated that the module 110-5 may perform any other suitable operations, such as permutation importance calculation, incremental training or testing, cross-validation, and the like, to determine the performance of the AI/ML model and thereby determine the contribution of the data to the performance of the AI/ML model, to determine the test coverage of the testing of the AI/ML model and thereby determine the contribution of the data to the test coverage, and/or to determine the coverage of the feature map according to training/test data and thereby determine the contribution of the data to the feature map coverage.

According to example embodiments, based on determining that the data contributes to one or more improvements, the contribution estimator module 110-5 may estimate or compute a contribution score representing the contribution of the data to the one or more improvements (e.g., improvement of the AI/ML model performance, the improvement of test coverage of the testing of the AI/ML model, the improvement of the feature map coverage, etc.) The contribution score may be defined in factor form, value form, percentage form, rank form, probability form, and the like.

Based on determining that the data contributes to the one or more improvements, the contribution estimator module 110-5 may be configured to provide the data to the database module 110-4. Accordingly, the database module 110-4 may be configured to store the data in one or more databases or storage mediums. In this regard, the database module 110-4 may organize the data into a structured format conducive to machine learning and model training/testing tasks (e.g., categorizing the data based on requirements of the models, labeling the data, etc.), store the data along with the corresponding features, metadata, or attributes (e.g., timestamps, sensor information, satisfied/unsatisfied data requirements, etc.), partition the data into appropriate subsets (e.g., subsets for training, subsets for testing, etc.), and retrieve the data and provide the retrieved data to other modules in the data collection system 110 when required. In some example embodiments, the database module 110-4 may comprise two or more database modules, including a database module that is configured to store training data, a database module that is configured to store test data, and a database module that is configured to store the price list.

In addition to the data received from the vehicle systems, the database module 110-4 may also store or manage one or more AI/ML models and one or more price lists (or data catalogs). The one or more AI/Ml models may include: one or more transformer models, one or more recurrent neural network (RNN) models, one or more generative adversarial network (GAN) models, one or more supervised/unsupervised learning models, and/or any other suitable type of models trained based on any other suitable learning architectures. The one or more price lists (or data catalogs) may include information of one or more target objects, as described hereinabove with reference to the example price list 300 in FIG. 3A.

Further, based on determining that the data contributes to the one or more improvements, the contribution estimator module 110-5 may be configured to trigger the payment module 110-6 to compensate the associated user (e.g., the owner of the vehicle which provides the data, etc.) Specifically, the module 110-5 may provide information of the data, such as the associated user information, the contribution score, and the like, to the payment module 110-6, and the payment module 110-6 may determine a compensation price for the user based thereon.

For instance, the payment module 110-6 may obtain the price list (or data catalog) from the database module 110-4, determine a base compensation price from a plurality of prices in the price list, and compute the compensation price based on the base compensation price and the contribution score.

By way of example, assuming that the base compensation price is 10 USD and the contribution score is 10% (indicating that the data contributes 10 percent improvement on the performance of the AI/ML model, test coverage, and/or feature map coverage, etc.), the module 110-6 may determine that the compensation price is 11 USD (i.e., 10 USD base compensation price with a 10% increment). According to example embodiments, the increment of the compensation price is according to a range of contribution scores (e.g., contribution scores between 0% to 10% will have a 0% increment, contribution scores between 11% to 20% will have a 5% increment, and the like.) In this case, the module 110-6 may determine, based on the contribution score of the data, an increment of the compensation price, and then apply the increment to the base compensation price, thereby computing the compensation price.

Upon determining the compensation price, the payment module 110-6 may provide information associated with the payment to a payment system (e.g., a banking system associated with the user to be compensated, etc.) The payment information comprises information of the user (e.g., account number, etc.), payment amount defined by the determined compensation price, payment currency (e.g., in USD, in JPY, etc.), and payment due date.

In view of the above, the data collection system 110 of example embodiments integrates and leverages multiple functional modules to effectively and efficiently acquire, validate, store, and utilize data from one or more vehicle systems, without restrictions of the geographical locations of the vehicle systems. Accordingly, by employing robust data validation, the system 110 ensures the reliability and quality of data before utilizing the data to train and/or test the AI/ML models and storing the data in the database. Further, by determining the contribution of the data to the improvement of the AI/ML models, the compensation price can be appropriately determined, thereby avoiding the situations of over-compensating and under-compensating the data providers.

Referring next to FIG. 4, which illustrates example functional modules of the vehicle system 120, according to one or more example embodiments. As illustrated in FIG. 4, the vehicle system 120 may include at least one user interface (UI) module 120-1, at least one data capturing module 120-2, and at least one sensor module 120-3. It is contemplated that the vehicle system 120 may include any other suitable modules or components, and may interoperate with other systems in the vehicle, such as an infotainment system, a navigation system, a lighting system, and the like. Further, the vehicle system 120 may be implemented or deployed in any suitable vehicle located in any suitable geographical location (e.g., a vehicle located in a region similar to/different from the region of the data collection system 110).

Similar to the modules in the data collection system 110, one or more of the modules 120-1 to 120-3 may be implemented in different forms of hardware, firmware, or a combination of hardware and software. In this regard, it is contemplated that one or more operations described herein with reference to each of the modules 120-1 to 120-3 may be performed by a hardware (e.g., a processor, etc.) upon executing a software or computer-executable instructions for implementing the modules 120-1 to 120-3. Further, it is contemplated that one or more of the modules 120-1 to 120-3 may be consolidated into a single module or may be implemented in the form of multiple modules (e.g., the data capturing module 120-2 and the sensor module 120-3 may be combined into a data sensing module, the sensor module 120-3 may be segregated into multiple modules each of which is associated with a specific sensor, etc.)

The UI module 120-1 may be configured to generate and present one or more UIs to engage one or more users (e.g., owner of the vehicle, driver of the vehicle, passenger of the vehicle, etc.) According to example embodiments, the module 120-1 may generate one or more graphical user interfaces (GUIs), one or more voice user interfaces (VUIs), and/or the like, and provide the GUIs/VUIs to the user via the user equipment (e.g., UE 130) and/or one or more devices in the vehicle (e.g., a navigation device, a head-up display (HUD), a speaker, etc.)

According to example embodiments, the UI module 120-1 may obtain or receive a price list (or a data catalog) from the data collection system 110, and then generate the one or more GUIs/VUIs that include the information of the price list (e.g., available target objects, data requirement(s) associated with each of the target objects, the associated base compensation price(s), etc.) Alternatively, the UI module 120-1 may provide the information of the one or more GUIs/VUIs to the user device (e.g., UE 130), such that the user device can generate and present the one or more GUIs/VUIs to the user based thereon. Accordingly, the user may review the available option(s) from the one or more GUIs/VUIs and then select one or more object(s) that he/she agrees to collect the associated data via the vehicle system 120. Upon receiving a user selection on one or more target objects, the UI module 120-1 may update the one or more GUIs/VUIs that include an interactive element (e.g., a confirmation button, a voice speech that requests the user confirmation, etc.) to request the user to confirm and approve the utilization of the vehicle to collect and provide data associated with the user-selected object(s).

Upon receiving approval or application from the user, the UI module 120-1 may continuously (or periodically) provide one or more user inputs to the data capturing module 120-1, thereby triggering one or more operations for capturing the data associated with the user-selected object(s) when available.

According to example embodiments, the UI module 120-1 may receive an audio input (e.g., from an onboard microphone) from the user and provide the same to the data capturing module 120-2. The module 120-2 may then be configured to determine whether or not the data-capturing operation should be triggered, based on determining whether or not the audio input includes a keyword associated with the object. As a non-limiting example, assuming that the target object is a “wild boar”, the data capturing module 120-2 may trigger the data capturing operation upon determining that the audio input includes a “wild boar”. Additionally or alternatively, upon receiving the application or approval from the user, the UI module 120-1 may provide the information associated with the user-selected object(s) to the data capturing module 120-2, and the module 120-2 may continuously (or periodically) trigger the sensor module 120-3 to capture one or more images of the environment around the vehicle. Subsequently, the data capturing module 120-2 may perform one or more object recognition to determine whether or not the target object(s) is included in the one or more images. Accordingly, based on determining that the target object(s) is included in the one or more images, the data capturing module 120-2 may determine that the data-capturing operation should be triggered and may further trigger the sensor module 120-3 to capture additional data (e.g., location data, weather data, additional image data, etc.) thereafter. According to example embodiments in which the user has selected multiple objects, the module 120-2 may concurrently or sequentially determine and trigger the data-capturing operations for the multiple objects in a similar manner.

Upon receiving a trigger from the data capturing module 120-2, the sensor module 120-3 may be configured to operate or activate the associated sensor(s) to perform one or more data-capturing operations to capture data surrounding the vehicle in which the vehicle system 120 is implemented. The data-capturing operations may include, for example, capturing (with an onboard camera, an infrared sensor, a Lidar sensor, etc.) an image of the environment around the vehicle, recording a location of the vehicle, and/or collecting one or more environmental data (e.g., timing data, weather data, temperature data, humidity data, lighting data, vehicle speed data, road condition, etc.) The module 120-3 may be configured to annotate or embed the information (e.g., location information, environmental information, etc.) to the image data, and then provide the image to the data capturing module 120-3.

According to example embodiments, the sensor module 120-3 may include a plurality of sensor modules, each of which is associated with a specific onboard sensor. For instance, a first sensor module may be associated with an image sensor (e.g., camera) and is dedicated to triggering and managing the data-capturing operation of the image sensor, a second sensor module may be associated with a location sensor (e.g., a GPS) and is dedicated for triggering and managing the data-capturing operation of the location sensor, and the like.

Upon capturing the data, the sensor module 120-3 may provide the captured data to the data capturing module 120-2. Accordingly, the data capturing module 120-2 may provide the captured data to the data collection system 110. According to example embodiments, the data capturing module 120-2 may preprocess the captured data before transmitting the data to the data collection system 110. For instance, the data capturing module 120-2 may compile or group the data according to the target object, may annotate or embed the data with the information of the user communication (e.g., user selection on the target objects, etc.), may combine image data and audio data to produce a video or an animation, and the like.

In view of the above, by leveraging the vehicle system 120 of example embodiments, vehicles located at multiple locations may be utilized to capture data for AI/ML models, upon receiving approval or application from the associated user. The vehicle system 120 may automatically trigger the data-capturing operations and then provide the captured data to the data collection system 110, without requiring user intervention.

Additionally or alternatively, the vehicle system 120 may continuously (or periodically) capture data (e.g., image, etc.) around the vehicle, and the user can review or playback the data (e.g., with a GUI/VUI on the user device) after the driving of the vehicle. Subsequently, the user may then select data corresponding to an object in the price list and upload the data to the data collection system 110.

Additionally or alternatively, the vehicle system 120 may continuously (or periodically) capture and upload data (e.g., image, etc.) around the vehicle and the data collection system 110 may continuously (or periodically) store the uploaded data (e.g., provide the data to the database module 110-4, etc.), for a purpose in addition to or in alternative to the purpose for being utilized by the model trainer/tester module 110-3, and the user can review or playback the data (e.g., with a GUI/VUI on the user device) after the driving of the vehicle. Subsequently, the user may then select data corresponding to an object in the price list and permit the data collection system 110 to use the data for the operations of the model trainer/tester module.

Next, descriptions of example components of the data collection system are provided. Referring to FIG. 5, which illustrates a block diagram of example components of a data collection system 500, according to one or more example embodiments. The system 500 in FIG. 5 may correspond to the system 110 in FIG. 1 and FIG. 2, thus it is contemplated that features described herein with reference to the system 110 and the system 500 may be applicable to each other, unless explicitly described otherwise. Further, one or more components of the system 110 (e.g., modules 110-1 to 110-6) may be implemented by one or more components of the system 500. According to example to embodiments, system 500 may be implemented in one or more servers, such as one or more edge servers, one or more central servers, and/or the like.

As illustrated in FIG. 5, the system 500 may include at least one bus 510, at least one processor 520, at least one memory 530, at least one storage component 540, at least one input component/output component 550, and at least one communication interface 560. It is contemplated that the system 500 may include more or less components than illustrated in FIG. 5, without departing from the scope of the present disclosure. For instance, in some example embodiments, input/output component 550 may include a dedicated input component and a dedicated output component that may operate independently from each other, a plurality of storage components 540 may be included, and the like.

The at least one bus 510 may include one or more components that permit communication among the components of system 500. For instance, the bus 510 may include a controller area network (CAN) bus, an Ethernet bus, a peripheral component interconnect express (PCIe) bus, and any other suitable types of bus that allow the components 520-560 to communicate with each other in real-time (or near real-time).

The at least one processor 520 may be implemented in hardware, firmware, or a combination of hardware and software. According to example embodiments, the processor 520 may include a central processing unit (CPU), a graphics processing unit (GPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component. In some example implementations, the processor 520 may include one or more processors capable of being programmed to perform one or more operations of the data collection system described herein. Further, the processor 520 may include a plurality of processing units, each of which is dedicated to performing a specific operation (e.g., each of the modules 110-1 to 110-6 in FIG. 2 may be assigned a dedicated processing unit, etc.)

The at least one memory 530 may include a random access memory (RAM), a read-only memory (ROM), and/or another type of dynamic or static storage device (e.g., a flash memory, a magnetic memory, and/or an optical memory) that stores information and/or instructions for use by the processor 520. The at least one storage component 540 may store information and/or software related to the operation and use of the system 500. For example, the storage component 540 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. According to example embodiments, the database module 110-4 (or one or more operations associated therewith) may be implemented by the memory 530 and/or the storage component 540.

According to example embodiments, the storage component 540 may be configured to store computer-readable or computer-executable instructions for implementing one or more functional modules of the data collection system (e.g., modules 110-1 to 110-6), one or more price lists (or data catalogs), one or more AI/ML models, data received from one or more vehicle systems, testing and/or training information, payment information, user information, one or more historical operations performed by the data collection system, one or more interactions or communications between the data collection system and the vehicle system(s) and the UE(s), and/or the like. The storage component 540 may provide the stored information to the memory 530 for the execution of the processor 520.

The at least one input/output component 550 may include one or more input components that permit the system 500 to receive information, such as via user input (e.g., a touch screen display, a keyboard, a keypad, a mouse, a button, a switch, and/or a microphone). Additionally or alternatively, the input/output component 550 may include one or more output components that provide output information from the system 500 (e.g., a display, a speaker, a navigation device, one or more light-emitting diodes (LEDs), etc.)

The at least one communication interface 560 may include a transceiver-like component (e.g., a transceiver and/or a separate receiver and transmitter) that enables the system 500 to communicate with other devices, such as via a wired connection, a wireless connection, or a combination of wired and wireless connections. Communication interface 560 may permit system 500 to receive information from one or more devices outside the vehicle (e.g., vehicle system 120, UE 130, etc.) and/or provide information thereto. For example, communication interface 560 may include an Ethernet interface, an optical interface, a coaxial interface, an infrared interface, a radio frequency (RF) interface, a universal serial bus (USB) interface, a Wi-Fi interface, a cellular network interface, or the like.

According to one or more example embodiments, the communication interface 560 may include at least one input/output (I/O) interface, at least one network interface, at least one storage interface, or the like, that enable the components 520-550 to communicate with other devices outside of the vehicle. Further, the communication interface 560 may include one or more application programming interfaces (APIs) that allow the system 500 (or one or more components included therein) to communicate with one or more software applications (e.g., software application deployed in the vehicle system, software application implemented in the UE, etc.) According to example embodiments, the data receiver module 110-1 (or one or more operations associated therewith) may be implemented by the communication interface 560.

System 500 may perform one or more operations of the data collection system described herein in response to the at least one processor 520 executing computer-executable instructions for implementing one or more of the functional modules 110-1 to 110-6 in FIG. 2. These computer-executable instructions may be stored by a non-transitory computer-readable recording medium, such as memory 530 and/or storage component 540. A computer-readable medium is defined herein as a non-transitory memory device. A memory device may include memory space within a single physical storage device or memory space spread across multiple physical storage devices.

Computer-executable instructions (e.g., software instructions, etc.) may be read into memory 530 and/or storage component 540 from another computer-readable medium or from another device (e.g., a remote server, an external storage, etc.) via the communication interface 560. When executed, the computer-executable instructions stored in memory 530 and/or storage component 540 may cause the processor 520 to perform one or more processes described herein. Additionally or alternatively, hardwired circuitry may be used in place of or in combination with software instructions to perform one or more processes described herein. Thus, implementations described herein are not limited to any specific combination of hardware circuitry and software.

Next, descriptions of example components of the vehicle system are provided. Referring to FIG. 6, which illustrates a block diagram of example components of a vehicle system 600, according to one or more example embodiments. The system 600 in FIG. 6 may correspond to the system 120 in FIG. 1 and FIG. 4, thus it is contemplated that features described herein with reference to the system 120 and the system 600 may be applicable to each other, unless explicitly described otherwise. Further, one or more components of the system 120 (e.g., modules 120-1 to 120-3) may be implemented by one or more components of the system 600. According to example embodiments, system 600 may be implemented in one or more vehicles and may interoperate with other systems and components of the vehicle, thereby facilitating efficient and effective data-capturing operations.

As illustrated in FIG. 6, the system 600 may include at least one bus 610, at least one processor 620, at least one memory 630, at least one storage component 640, at least one onboard sensor 650, at least one input component/output component 660, and at least one communication interface 670. It is contemplated that the system 600 may include more or less components than illustrated in FIG. 6, without departing from the scope of the present disclosure. For instance, in some example embodiments, the system 600 may include a plurality of onboard sensors 650, the input/output component 650 may include a dedicated input component and a dedicated output component that may operate independently from each other, a plurality of storage components 640 may be included, and the like.

Further, it is contemplated that the role, function, and examples of the components 610, 620, 630, 640, 660, and 670 may be similar to those described above with reference to the components 510, 520, 530, 540, 550, and 560 in FIG. 5, respectively. Thus, redundant descriptions associated therewith may be omitted herein below for conciseness.

Similar to the bus 510, the at least one bus 610 may include one or more components that permit communication among the components of system 600 and permit communication among said components and other systems/components in the vehicle. In addition to the described examples such as the CAN bus and the Ethernet bus, the bus 610 may further include bus dedicated to automotive components or applications, such as: a local interconnect network (LIN) bus, an automotive Ethernet bus, and any other suitable types of bus that allow vehicle components, such as components 620-670, actuators, electronic control units (ECUs), and the like, to communicate with each other in real-time (or near real-time).

The processor 620 may include one or more processors capable of being programmed to perform one or more operations of the vehicle system described herein. Further, the processor 620 may include a plurality of processing units, each of which is dedicated to performing one or more specific operations (e.g., each of the modules 120-1 to 120-3 in FIG. 4 may be assigned a dedicated processing unit, etc.)

The at least one memory 630 may store information and/or instructions for use by the processor 620. The at least one storage component 640 may store information and/or software related to the operation and use of the system 600. According to example embodiments, the storage component 640 may be configured to store computer-readable or computer-executable instructions for implementing one or more modules of the system (e.g., modules 120-1 to 120-3), one or more AI/ML models for implementing the one or more operations of the modules 120-1 to 120-3, one or more applications or approvals received from the associated user, one or more inputs for triggering the data-capturing operations, one or more raw data captured by the at least one onboard sensor, one or more data preprocessed by the data capturing module, one or more data obtained from external components (e.g., UE, data collection system, another vehicle system, etc.), one or more historical operations performed by the vehicle system, one or more feedbacks provided to and/or received from a user (e.g., vehicle owner, driver, passenger, etc.), and/or the like. The storage component 640 may provide the stored information to the memory 630 for the execution of the processor 620.

The at least one onboard sensor 650 may include one or more sensors installed in the vehicle and configured to detect, measure, and capture respective sensing data around the environment of the vehicle. For instance, the at least one sensor 650 may include one or more of: an accelerometer which measures and captures data associated with the acceleration/deceleration of the vehicle, the vehicle speed, and/or the vehicle travel distance; an image sensor (e.g., camera, infrared, etc.) which detects and captures image data surrounding or nearby the vehicle; a light detection and ranging (Lidar) sensor which detects and captures data associated with light in one or more light spectrums, such as the visible spectrum, the infrared spectrum, the ultraviolet spectrum, and/or any other light spectrums; an audio sensor (e.g., microphone, etc.) which detects and captures audio data internal and/or external to the vehicle; a temperature sensor which measures and captures data associated with temperature internal and/or external to the vehicle; a location sensor (e.g., global positioning system (GPS) receiver, inertial measurement unit (IMU), etc.) which measures and captures data associated with the location, position, and/or orientation of the vehicle; a contact sensor (e.g., pressure detector, impact detector, etc.) which detects and captures data between a portion of the vehicle and an object; an air sensor which measures and captures data associated with the air (e.g., oxygen level, pollution level, humidity level, etc.) internal and/or external to the vehicle; a weather sensor (e.g., rain sensor, snow sensor, wind speed sensor, visibility sensor, etc.) which measures and captures the weather conditions (e.g., possibility and intensity of rainfall, presence of snow or snow accumulation, direction of wind flow and potential wind gusts, potential fog/mist/haze, etc.) around the vehicle; a proximity sensor (e.g., ultrasonic sensor, LiDAR, radar, etc.) which measures the distance between the vehicle and an surrounding object (e.g., a bicycle); an FM/AM receiver which detects radio signal from a road infrastructure of a radio station, thereby receiving information (e.g., broadcast weather reports, traffic updates, emergency alerts, local news, etc.); and any other sensors suitable to be deployed in the vehicle.

Similar to the input/output component 550, the at least one input/output component 660 may include one or more input components that permit the system 600 to receive information and/or one or more output components that provide output information from the system 600. Further, similar to the communication interface 560, the at least one communication interface 670 may include a transceiver-like component (e.g., a transceiver and/or a separate receiver and transmitter) and the like that enables the system 600 to communicate with other devices.

System 600 may perform one or more operations of the vehicle system described herein in response to the at least one processor 620 executing computer-executable instructions for implementing one or more of the functional modules 120-1 to 120-3 in FIG. 4. These computer-executable instructions may be stored by a non-transitory computer-readable recording medium, such as memory 630 and/or storage component 640. A computer-readable medium is defined herein as a non-transitory memory device. A memory device may include memory space within a single physical storage device or memory space spread across multiple physical storage devices.

Computer-executable instructions (e.g., software instructions, etc.) may be read into memory 630 and/or storage component 640 from another computer-readable medium or from another device (e.g., a remote server, an external storage, etc.) via the communication interface 670. When executed, the computer-executable instructions stored in memory 630 and/or storage component 640 may cause the processor 620 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

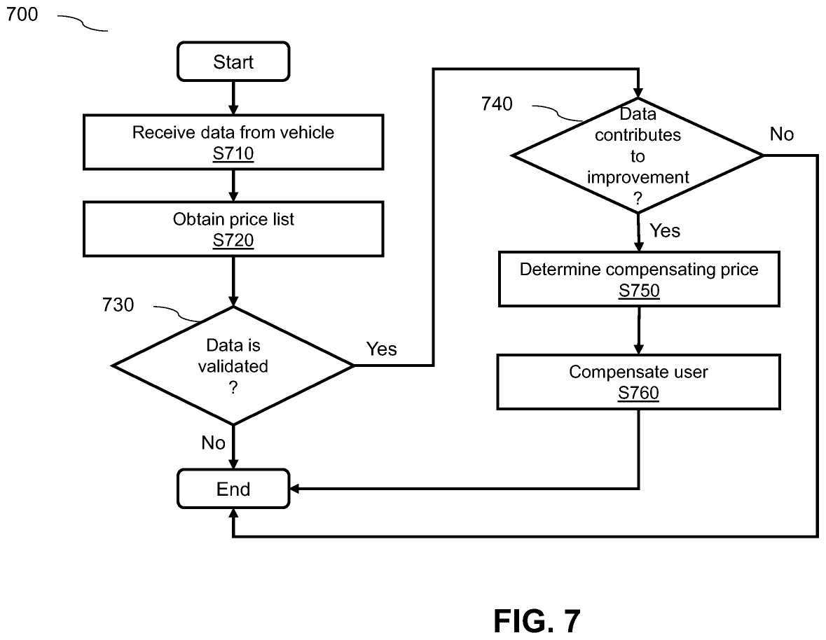

FIG. 7 illustrates a flow diagram of an example method 700 performed by a data collection system to collect data from a vehicle, according to one or more example embodiments. The vehicle may be located in a region different from the region of the data collection system. The method 700 may be performed by at least one processor (e.g., processor 520) of the data collection system, upon executing the associated computer-readable instructions stored in at least one memory storage (e.g., memory 530, storage component 540, etc.) of the system.

Referring to FIG. 7, at operation S710, the at least one processor may be configured to obtain, from the vehicle (or a vehicle system implemented therein), data captured by at least one onboard sensor in the vehicle. According to example embodiments, the data may include an image captured by an image sensor in the vehicle. Operation S710 may be performed by the at least one processor upon executing the computer-readable instructions for implementing a data receiver module, of which the specific operations have been described above with reference to module 110-1 in FIG. 2. Thus, further descriptions regarding the specific operations for obtaining data from the vehicle may be omitted below for conciseness.

At operation S720, the at least one processor may be configured to obtain a price list. For instance, the at least one processor may obtain, from a storage medium (e.g., memory 530, storage component 540, etc.), the price list (or data catalog). Descriptions of an example price list have been provided above with reference to FIG. 3A.

It is contemplated that operations S710 and S720 may be performed in any suitable sequences. For instance, operation S720 may be performed concurrently with operation S710, may be performed prior to operation S710, and the like, without departing from the scope of the present disclosure.

Upon obtaining the data and the price list, method 700 may proceed to operation S730, at which the at least one processor may be configured to validate the data based on the price list. For instance, the at least one processor may perform an object recognition to identify an object included in the data, and then determine whether or not the identified object is associated with at least one object included in the price list. Based on determining that the identified object is associated with the at least one object, the at least one processor may determine whether or not the data fulfills at least one data requirement. Based on determining that the data fulfills the at least one data requirement, the at least one processor may determine that the data is validated. Otherwise, the at least one processor may determine that the data is invalid, and the method 700 may be terminated.

According to example embodiments, the at least one processor may generate one or more interfaces (e.g., GUIs, etc.) that include information of the data, and then present the one or more interfaces to one or more human operators to request the one or more human operators to verify the data via interacting with the one or more interfaces. Accordingly, based on one or more feedbacks from the one or more human operators via the one or more interfaces, the at least one processor may determine whether or not the data is validated. For instance, the at least one processor may determine whether or not an object in the data is associated with at least one object included in the price list, whether or not one or more data requirements associated with the object are satisfied, and the like. Based on determining that the data fulfills the at least one data requirement, the at least one processor may determine that the data is validated. Otherwise, the at least one processor may determine that the data is invalid, and the method 700 may be terminated.

According to example embodiments in which the data includes one or more images captured by the image sensor in the vehicle, the at least one data requirement in the price list may include a resolution of the image in which the object is included. In this case, the at least one processor may validate the data by determining the image resolution of the one or more images, and then determining whether or not the image resolution satisfies the image resolution requirement specified in the price list. Accordingly, based on determining that the image resolution of the one or more images satisfies the image resolution specified in the price list, the at least one processor may determine that the data is validated. Otherwise, the at least one processor may determine that the data is invalid, and the method 700 may be terminated.

According to example embodiments, the at least one processor may further validate the data by checking whether or not the data is real data that was captured by the vehicle system (or one or more onboard sensors in the vehicle) or is fake data that was fabricated with malicious intent. Accordingly, based on determining that the data fulfills at least one data requirement and is real data, the at least one processor may determine that the data is validated. Otherwise, based on determining that the data does not satisfy the at least one data requirement or is fake data, the at least one processor may determine that the data is invalid and the method 700 may be terminated.

Operations S720 and S730 may be performed by the at least one processor upon executing the computer-readable instructions for implementing a data validator module, of which the specific operations have been described above with reference to module 110-2 in FIG. 2. Thus, further descriptions regarding the specific operations for obtaining the price list and for validating the data may be omitted below for conciseness.

Referring still to FIG. 7, based on determining that the data is validated, the method 700 may proceed to operation S740, at which the at least one processor may be configured to determine whether or not the data contributes to the one or more improvements, such as the improvement on the performance of at least one AI/ML model, the test coverage, and/or the feature map coverage. According to example embodiments, the at least one processor may determine whether or not the data contributes to the one or more improvements by training and/or testing the at least one AI/ML model with the data and measuring one or more performance metrics (e.g., accuracy, precision, F-score, average precision, etc.) of the trained and/or tested AI/ML model. Subsequently, the at least one processor may determine, based on the one or more performance metrics, a contribution of the data in improving the performance of the at least one AI/ML model. For instance, based on determining that the trained/tested AI/ML model has a higher accuracy than the untrained/untested AI/ML model, the at least one processor may determine that the data contributes to the improvement of the performance. Further, the at least one processor may determine whether or not the data contributes to the one or more improvements by testing the AI/ML model with a test data set to determine a testing coverage of the existing test data set and then determine whether or not the data contributes or improve the testing coverage. Furthermore, the at least one processor may determine whether or not the data contributes to the one or more improvements by generating a feature map and then determine whether or not the data contributes or improves the feature map coverage. Example operations associated therewith have been described above with reference to the contribution estimator module 110-5 in FIG. 2, thus redundant descriptions associated therewith may be omitted below for conciseness.

According to example embodiments, based on determining that the data contributes to the one or more improvements, the at least one processor may estimate or compute a contribution score representing the contribution of the data to the one or more improvements. The contribution score may be defined in factor form, value form, percentage form, rank form, probability form, and the like. Further, based on determining that the data contributes to the one or more improvements, the at least one processor may be configured to provide the data to the a database (or a storage medium such as storage component 540), wherein the database is configured to store data associated with the AI/ML model, such as the training data and/or the testing data.

Operation S740 may be performed by the at least one processor upon executing the computer-readable instructions for implementing a model trainer/tester module and a contribution estimator module, of which the specific operations have been described above with reference to module 110-3 and module 110-5 in FIG. 2. Thus, further descriptions regarding the specific operations for determination of the contribution of data may be omitted below for conciseness.

Referring still to FIG. 7, based on determining that the data contributes to the one or more improvements of the AI/ML model, the method 700 may proceed to operation S750. Otherwise, the method 700 may be terminated. At operation S750, the at least one processor may be configured to determine a price for compensating a user associated with the vehicle. For instance, the at least one processor may determine, from among a plurality of prices included in the price list, a base compensation price associated with the data, and then compute the price based on the base compensation price and the contribution score.

Upon determining the price, the method 700 may proceed to operation S760, at which the at least one processor may be configured to compensate the user based on the determined price. For instance, the at least one processor may provide information associated with the payment to a payment system (e.g., a banking system associated with the user to be compensated, etc.) The payment information may include information of the user (e.g., account number, etc.), a payment amount defined by the determined price, a payment currency (e.g., in USD, in JPY, etc.), and a payment due date. In some example embodiments, in addition to or in alternative to directly paying the compensation to the user, the at least one processor may provide information of a user account of a service that the user is currently using and paying a fee for the service so that the fee to be charged to the user is reduced or discounted according to the compensation price.

Operations S750 and S760 may be performed by the at least one processor upon executing the computer-readable instructions for implementing a payment module, of which the specific operations have been described above with reference to module 110-6 in FIG. 2. Thus, further descriptions regarding the specific operations for determining the compensation price and compensating the user may be omitted below for conciseness.

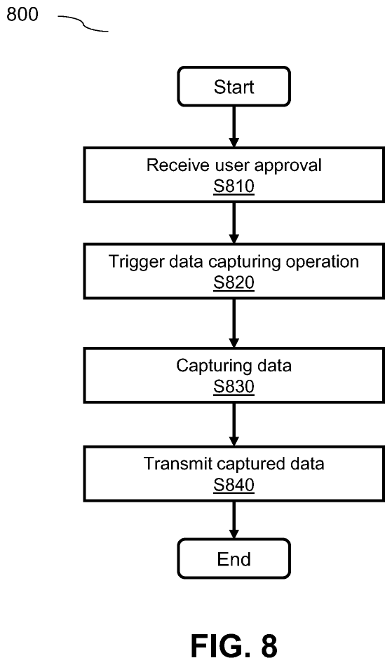

FIG. 8 illustrates a flow diagram of an example method 800 performed by a vehicle system to provide data to a data collection system, according to one or more example embodiments. The vehicle system may be implemented in a vehicle located in a region different from the data collection system. The method 800 may be performed by at least one processor (e.g., processor 620) of the vehicle system, upon executing the associated computer-readable instructions stored in at least one memory storage (e.g., memory 630, storage component 640, etc.) of the vehicle system.

Referring to FIG. 8, at operation S810, the at least one processor may be configured to obtain a user approval or an application to utilize the vehicle to collect and provide data associated with an object. The at least one processor may receive the user approval or application from a user device (e.g., UE 130) via a communication interface (e.g., interface 670), or may receive the user approval or application directly from an input component (e.g., component 660) in the vehicle system.

According to example embodiments, the at least one processor may obtain, from the data collection system, a price list that includes a plurality of objects, at least one data requirement associated with each of the objects, and a base compensation price associated with each of the objects. Accordingly, the at least one processor may generate at least one GUI including the information of the price list, and then present the GUI to the user. Subsequently, the at least one processor may receive, from the user via the GUI, a user selection on the object. Accordingly, the at least one processor may update the GUI to include an interactive element (e.g., button, etc.) to request the user to approve or agree on the utilization of the vehicle to capture and provide data associated with the selected object. Next, the at least one processor may receive, from the user via the updated GUI, a user interaction with the interactive element indicating that the user has approved or rejected the utilization of the vehicle to capture and provide data associated with the selected object. It is contemplated that the at least one processor may also present the information of the price list and receive one or more user feedbacks via one or more VUIs in a similar manner, without departing from the scope of the present disclosure.

Operation S810 may be performed by the at least one processor upon executing the computer-readable instructions for implementing a UI module, of which the specific operations have been described above with reference to module 120-1 in FIG. 4. Thus, further descriptions regarding the specific operations for interacting with the user and receiving the user approval/application may be omitted below for conciseness.

Upon receiving the user approval, the method 800 may proceed to operation S820, at which the at least one processor may be configured to trigger one or more operations to capture data. According to example embodiments, the at least one processor may receive an audio input from the user, and then determine whether or not the audio input includes a keyword associated with the target object. Accordingly, based on determining that the audio input includes the keyword, the at least one processor may determine that the one or more operations should be triggered to capture the data. Additionally or alternatively, the at least one processor may obtain an image of the environment around the vehicle, and then perform object recognition to determine whether or not the target object is included in the image. In this case, based on determining that the image includes the object, the at least one processor may determine that the one or more operations should be triggered to capture the data.

Subsequently, at operation S830, the at least one processor may instruct one or more onboard sensors in the vehicle to perform one or more operations for capturing data surrounding the vehicle. The one or more operations may include capturing an image of the environment around the vehicle, recording the location of the vehicle, and embedding information of the location to the image. It is contemplated that other sensor data (e.g., voice data, weather data, etc.) may be captured and be embedded to the image, in a similar manner.

Operation S830 may be performed by the at least one processor upon executing the computer-readable instructions for implementing a sensor module, of which the specific operations have been described above with reference to module 120-3 in FIG. 4. Thus, further descriptions regarding the specific operations for performing the data-capturing operations may be omitted below for conciseness.

Upon capturing the data, the method 800 may proceed to operation S840, at which the at least one processor may be configured to transmit the captured data to the data collection system. Operations S820 and S840 may be performed by the at least one processor upon executing the computer-readable instructions for implementing a data capturing module, of which the specific operations have been described above with reference to module 120-2 in FIG. 4. Thus, further descriptions regarding the specific operations for triggering the data-capturing operations and transmitting the captured data may be omitted below for conciseness.

According to example embodiments, the at least one processor may be configured to continuously (or periodically) capture and upload data to the data collection system. In this regard, the data collection system may continuously (or periodically) store the uploaded data. Accordingly, the user may review or playback the data (e.g., with a GUI/VUI presented by the user device) after the driving of the vehicle, and then select data corresponding to an object in the price list. Subsequently, the selected data may be utilized for the purposes of training and/or testing one or more AI/ML models.

In view of at least the above, example embodiments provide a system, a method, or the like, that effectively and efficiently collects real data under various conditions for training and/or testing AI/ML models. Further, data from different regions may be collected, without the restrictions of geographical locations. Furthermore, users involved in the data collection procedures may be appropriately compensated, thereby encouraging the users to participate in the data collection procedures. In addition, the data may be validated and the contribution of the data in improving the performance of the AI/MI model may be determined, before compensating the user or storing the data into the database, thereby avoiding wastage of resources on invalid or low-quality data.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A method performed by at least one processor of a system to collect data from a vehicle, the method comprising:
receiving data from the vehicle;
obtaining a price list;
validating the data based on the price list;
based on determining that the data is validated, determining whether or not the data contributes to one or more improvements of at least one artificial intelligence (AI)/Machine Learning (ML) model, wherein the one or more improvements comprise one or more of:
an improvement in performance of the at least one AI/ML model, an improvement in test coverage, and an improvement in feature map coverage;
based on determining that the data contributes to the one or more improvements, determining a price for compensating a user associated with the vehicle; and
compensating the user based on the determined price.

2. The method according to claim 1, wherein the validating the data comprises:
performing an object recognition to identify an object included in the data;
determining whether or not the identified object is associated with at least one object included in the price list;
based on determining that the identified object is associated with the at least one object, determining whether or not the data fulfills at least one data requirement; and
based on determining that the data fulfills the at least one data requirement, determining that the data is validated.

3. The method according to claim 1, wherein the validating the data comprises:
generating at least one interface including the information of the data;
presenting the at least one interface to at least one human operator;
receiving, from the at least one interface, one or more feedbacks from the at least one human operator; and
determining, based on the one or more feedbacks, whether or not the data is validated.

4. The method according to claim 2, wherein the data comprises an image captured by an image sensor in the vehicle, and wherein the at least one data requirement comprises a resolution of the image.

5. The method according to claim 2, wherein the validating the data comprises:
checking whether or not the data is real data which was captured by one or more onboard sensors in the vehicle or is fake data; and
based on determining that the data fulfills at least one data requirement and is real data, determining that the data is validated.

6. The method according to claim 1, wherein the determining whether or not the data contributes to the improvement of the performance comprises:
training the at least one AI/ML model with the data;
measuring one or more performance metrics of the trained AI/ML model; and
determining, based on the one or more performance metrics, a contribution of the data in improving the performance of the at least one AI/ML model.

7. The method according to claim 1, further comprising:
based on determining that the data contributes to the improvement of the performance, computing a contribution score representing the contribution of the data to the improvement of the performance.

8. The method according to claim 7, wherein the determining the price comprises:
determining, from among a plurality of prices included in the price list, a base compensation price; and
computing the price based on the base compensation price and the contribution score.

9. The method according to claim 8, wherein the compensating the user comprises:
providing payment information to a payment system, wherein the payment information comprises information of the user, a payment amount defined by the determined price, payment currency, and payment due date.

10. The method according to claim 1, further comprising:
based on determining that the data contributes to the improvement of the performance, providing the data to a database storing data associated with the at least one AI/ML model.

11. The method according to claim 1, wherein the vehicle is located at a region different from the system.

12. A system for collecting data from a vehicle, the system comprising:
a memory storage storing computer-executable instructions; and
at least one processor communicatively coupled to the memory storage, wherein the at least one processor is configured to execute the instructions to:
receive data from the vehicle;
obtain a price list;
validate the data based on the price list;
based on determining that the data is validated, determine whether or not the data contributes to one or more improvements of at least one artificial intelligence (AI)/Machine Learning (ML) model, wherein the one or more improvements comprise one or more of: an improvement in performance of the at least one AI/ML model, an improvement in test coverage, and an improvement in feature map coverage;
based on determining that the data contributes to the one or more improvements, determine a price for compensating a user associated with the vehicle; and
compensate the user based on the determined price.

13. The system according to claim 12, wherein the at least one processor is configured to validate the data by:
performing an object recognition to identify an object included in the data;
determining whether or not the identified object is associated with at least one object included in the price list;
based on determining that the identified object is associated with the at least one object, determining whether or not the data fulfills at least one data requirement; and
based on determining that the data fulfills the at least one data requirement, determining that the data is validated.

14. The method according to claim 1, wherein the at least one processor is configured to validate the data by:
generating at least one interface including the information of the data;
presenting the at least one interface to at least one human operator;
receiving, from the at least one interface, one or more feedbacks from the at least one human operator; and
determining, based on the one or more feedbacks, whether or not the data is validated.

15. The system according to claim 13, wherein the data comprises an image captured by an image sensor in the vehicle, and wherein the at least one data requirement comprises a resolution of the image.

16. The system according to claim 13, wherein the at least one processor is configured to validate the data by:
checking whether or not the data is real data which was captured by one or more onboard sensors in the vehicle or is fake data; and
based on determining that the data fulfills at least one data requirement and is real data, determining that the data is validated.

17. The system according to claim 12, wherein the at least one processor is configured to determine whether or not the data contributes to the improvement of the performance by:
training the at least one AI/ML model with the data;
measuring one or more performance metrics of the trained AI/ML model; and
determining, based on the one or more performance metrics, a contribution of the data in improving the performance of the at least one AI/ML model.

18. The system according to claim 12, wherein the at least one processor is further configured to:
based on determining that the data contributes to the improvement of the performance, compute a contribution score representing the contribution of the data to the improvement of the performance.

19. The system according to claim 18, wherein the at least one processor is configured to determine the price by:
determining, from among a plurality of prices included in the price list, a base compensation price; and
computing the price based on the base compensation price and the contribution score.

20. The system according to claim 19, wherein the at least one processor is configured to compensate the user by:
providing payment information to a payment system, wherein the payment information comprises information of the user, a payment amount defined by the determined price, payment currency, and payment due date.
